(19) United States
(12) Patent Application Publication
(10) Pub. No.: US 2004/0089599 A1
(43) Pub. Date: May 13, 2004

(54) Continuous filtration device with pivoting cells

(75) Inventor: Serge Kurowski, Neuville-en-Condroz (BE)

Correspondence Address: MICHAEL BEST & FRIEDRICH LLC, 401 NORTH MICHIGAN AVENUE, SUITE 1700, CHICAGO, IL, 60611-4212, US

(73) Assignee: PRAYON TECHNOLOGIES, Engis (BE)

(21) Appl. No.: 10/697,601

(22) Filed: Oct. 29, 2003

Related U.S. Application Data
(63) Continuation of application No. PCT/BE02/00067, filed on May 2, 2002.

(30) Foreign Application Priority Data
May 3, 2001 (BE) 010307

(51) Int. Cl. B01D 33/00

(52) U.S. Cl. 210/330; 210/331; 210/345

(57) ABSTRACT

A continuous fluid filtration device having filtration cells disposed in a carousel around a rotation axis so as to be able to pivot about a tilt axis including apparatus for discharging the filtrate from the cells with at least one outlet orifice at the bottom of each cell, a central collector and a connection allowing flow of the filtrate between the outlet orifice and the collector, where the connection for each cell includes a flexible conduit in which, in the filtration position of the cell, no area of the flexible conduit is lower than another area of the conduit situated downstream with respect to the flow of the filtrate, the flexible conduit being arranged so as not to undergo any elongation during tilting of the cell.

### BACKGROUND OF THE INVENTION

The present invention relates to a continuous fluid filtration device, comprising: (a) filtration cells each having an opening towards the top, through which they are supplied with fluid to be filtered and which is fitted with a filter bed which, in the filtration position of the cells, allows passage of a filtrate and retention of a filtration cake, and a bottom, these cells being disposed in a carousel around a rotation axis and each arranged so as to be able to pivot about a tilt axis, tangential to a horizontal circle having the rotation axis as its centre, (b) means of supporting the filtration cells, which support each cell so that it can perform a revolution about the rotation axis, (c) means of driving the filtration cells which drive them in revolution about the rotation axis, (d) means of moving the filtration cells which cause a tilting movement thereof about their tilt axis, during their revolution about the rotation axis, and (e) means of discharging the filtrate from the cells, comprising at least one outlet orifice at the bottom of each cell, a central collector and connection means allowing flow of the filtrate between the said at least one outlet orifice and the collector.

Filtration devices with cells in a carousel, which are in particular in use in the production of phosphoric acid, have already been known for a long time. Amongst others, it is possible to cite the following patents and patent applications U.S. Pat. No. 3,389,800, BE-A-768591, BE-A-847088, U.S. Pat. No. 4,721,566, WO-90/13348 and WO 92/20426. Each of these documents describes a filtration process in which the filtration cells, trapezoidal in shape in plan view, turn in a carousel about a rotation axis and are at a given moment tilted about a radial axis to allow discharge of the filtration cake and washing of the cell.

Given this tilting about a horizontal radial axis, a sufficient space between the adjacent cells must be provided to allow the aforementioned tilting, without collision between these cells. The result is a loss in filtering surface and therefore in capacity of the device.

A filtration device of the type described at the start has also already been provided (see for example U.S. Pat. No. 1,028,789). This device has the drawback of requiring flow of the filtrate through a rotary joint, concentric with the tilt axis of the cell and forming part of the bearing thereof. Such a joint necessarily gives rise to wear on the friction parts and it is necessary to provide air inlets into the vacuum circuit, which results in a cooling of the filtrates and crystallisation thereof in this circuit. Moreover, the cell tilting mechanism, which is complicated, is situated below the cell, that is to say in an area with a risk of corrosion where it will inevitably come into contact with the corrosive fluids fed into the cells.

A filtration device is also known where the cells in the carousel tilt about a tangential axis (see U.S. Pat. No. 2,768,753). In this device, the collector is situated, in a plan view, outside the filtration cells with respect to the rotation axis and the outlet orifice of each cell rests directly on this collector to a vacuum source by sliding on it. No pressurised gas source is provided for assisting the unsticking of the solid matter and washing of the filtration bed in the tilted position. Discharge of the solid matter is obtained by impact and stoppage of the tilting movement on a stop.

The aim of the present invention is to avoid these drawbacks, whilst providing a relatively simple and less expensive device which requires appreciably reduced forces for obtaining discharge of the filtration cake from the cells and cleaning thereof, and which allows discharge without leakage of filtrate and without excessive wear on the discharge means.

### SUMMARY OF THE INVENTION

To resolve these problems, there is provided, according to the invention, a filtration device as described at the start, in which the said connection means for each cell comprise a flexible conduit, in which, in the filtration position of the cell, no area of the flexible conduit is lower than another area of this conduit situated downstream with respect to the flow of the filtrate, the flexible conduit being arranged so as not to undergo any elongation during the tilting of the cell.

This device makes it possible to make the cells tilt whilst their lateral edges remain equidistant. It is therefore possible to bring the cells closer to the centre by reducing the separation between them to the maximum possible extent and either to increase the overall filtration surface of the device for the same size or to keep this at the same value for an appreciably smaller size. In addition, through this arrangement, the filtered liquid flows continuously, without slowing down, through the flexible conduit. The latter undergoes no elongation during the tilting and, given its arrangement between the outlet orifice of a cell and a collector disposed centrally, the flexible conduit also does not undergo any twisting force, during the tilting of the cells. Fatigue on the connecting means is therefore minimal.

According to one embodiment of the invention, in a radial section passing through the device, the flexible conduit in the filtration position of the cell extends downwards from an outlet orifice along a substantially vertical axis and then, at a height lower than the tilt axis, is angled in the direction of the collector so as to continuously have a downward slope, and the flexible conduit in the tilting position of the cell extends substantially horizontally from the outlet orifice as far as the tilt axis, and is then angled in the direction of the collector.

Advantageously, the tilt axis is supported in at least one bearing having a first outside diameter D1, the flexible conduit having a second outside diameter D2 and the distance between the tilt axis, and the above mentioned substantially vertical axis of the flexible conduit is equal to or greater than 0 and less than or equal to D1+D2. This arrangement, as close as possible, between the tilt axis and the vertical axis of the conduit advantageously makes it possible not to subject the flexible conduit to an elongation force during the tilting.

According to an improved embodiment of the invention, the device comprises, for each flexible conduit, a support which turns about the rotation axis simultaneously with the filtration cells. In this way, the support prevents the flexible conduit, under its own weight or under its weight when the filtrate is flowing therein, from having a tendency to flex downwards in a position in which it is no longer continuously in a downward slope in the direction of the collector.

According to a particular embodiment of the invention, the collector is connected to a source of negative pressure which the flexible conduits, connected to the filtration cells in the filtration position, communicate to them, below their filtering bed, and the collector is also a distributor connected to a source of pressurised gas which the flexible conduits connected to the filtration cells in the tilted position communicate to the latter, to assist with the detachment of the filtration cake from the filter bed.

According to another embodiment of the invention, the aforementioned movement means comprise a roller arranged on each cell so as to be able to turn freely about a pivot axis, and a guide rail arranged fixedly at one point on the filtration device so as to receive the roller of each driven filtration cell and to guide it so as to cause the said tilting movement of the cell.

Other embodiments of the device according to the invention are indicated in the accompanying claims.

Other details and particularities of the invention will emerge from the description given as an accompaniment, non-limitingly, with reference to the accompanying drawings.

### BRIEF DESCRIPTION OF THE FIGURES

In the various figures described below, the identical or similar elements are designated by the same references. These figures are schematic representations and, at different points, many elements have been omitted in order to facilitate reading thereof.

FIG. 1 depicts a partially broken plan view of a filtration device according to the invention.

FIG. 2 depicts a view in section along the line II-II in FIG. 1.

FIG. 3 depicts, to an enlarged scale, a plan view of the guide rail along the line III-III in FIG. 2.

FIG. 4 depicts, to an enlarged scale, a view of the guide rail in section along the line IV-IV in FIG. 2.

FIG. 5 depicts a detail of the left-hand part of FIG. 2 to an enlarged scale.

FIG. 6 depicts a view in section along the line VI-VI in FIG. 5.

FIG. 7 depicts a variant of the arrangement provided in FIG. 6.

FIG. 8 depicts a view in section along the line VIII-VIII in FIG. 7.

### DESCRIPTION OF THE PREFERRED EMBODIMENTS

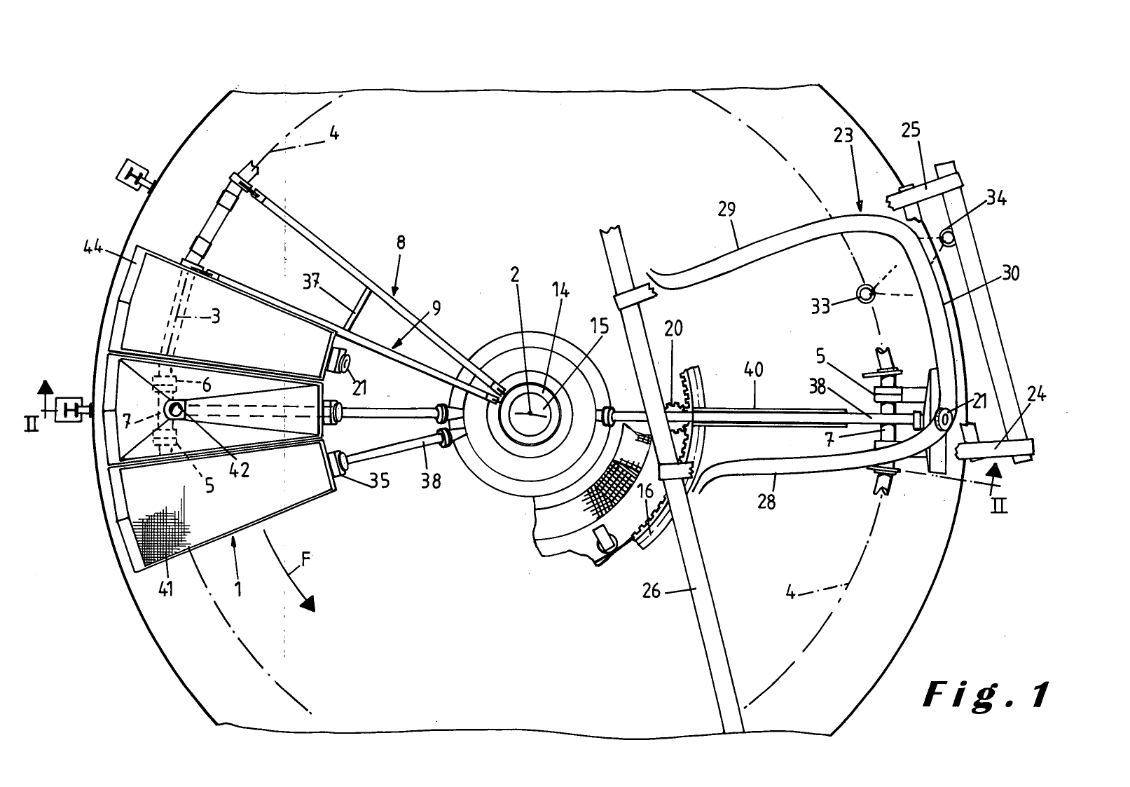

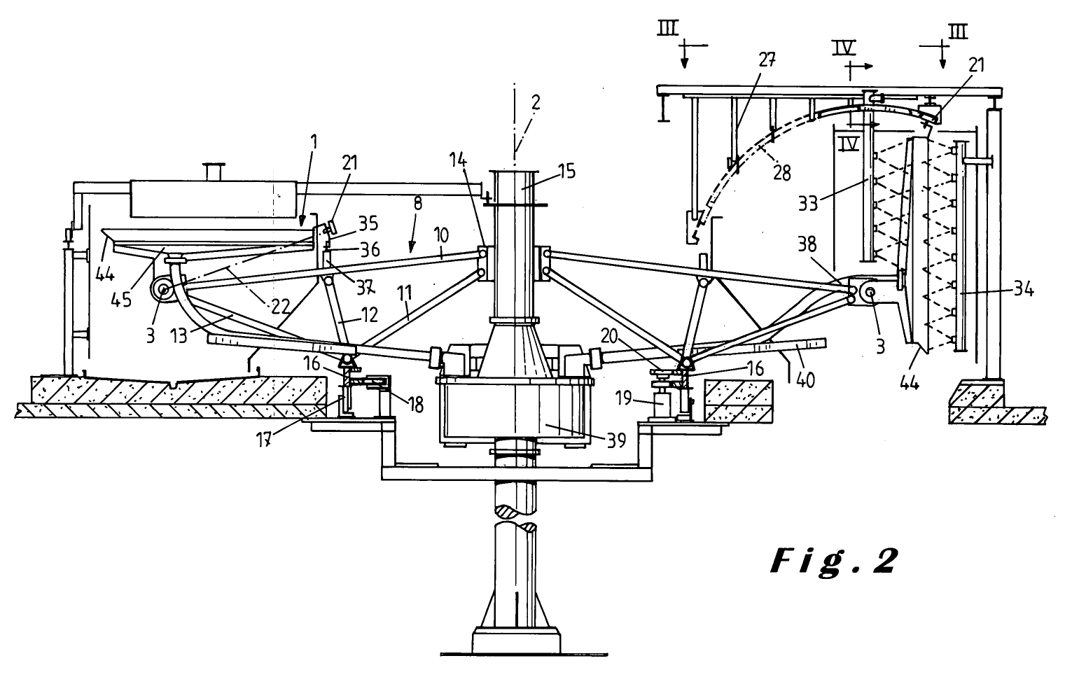

In the example embodiment depicted in FIGS. 1 and 2, filtration cells 1 in the form of a vessel, having an opening disposed upwards during filtration, are arranged in a carousel about a vertical rotation axis 2. These cells 1 are provided with a horizontal filter bed 41 above which a fluid to be filtered is supplied and below which a filtrate is collected.

According to the invention, each cell 1 is capable of turning about a tilt axis 3 which is arranged tangentially to an imaginary horizontal circle 4 whose centre is formed by the rotation axis 2.

In the example embodiment illustrated, the bottom 45 of each cell 1 is provided with two bearings 5 and 6 through which a shaft 7 is passed so as to allow free tilting of the cell about the shaft 7. This shaft 7 is coaxial with the aforementioned tilt axis 3.

As illustrated in FIGS. 1 and 2, this shaft 7 is supported by two support linkages 8 and 9, each of these linkages being formed by rods 10 to 13 disposed in a triangle. At one end, the rods 10 and 11 are fixed to a ring 14 which surrounds a central shaft 15 so as to be able to turn freely about the latter and without contact therewith. This central shaft 15 is coaxial with the rotation axis 2. At its other end, the rod 10 is connected to the shaft 7 and the rod 11 to a circular rotary chassis 16 provided with a rack. The rod 13 connects the shaft 7 to the circular chassis 16 and the rod 12 connects the latter to a central part of the rod 10. Each cell is thus supported by two frameworks which are both light and non-deformable, which undergo only traction and compression forces.

The circular chassis 16, arranged coaxial with the rotation axis 2, is supported and guided by sets of rollers with respectively horizontal and vertical axes 17 and 18, on which it can turn in a horizontal plane about the rotation axis 2. In the example illustrated, a drive motor 19 actuates a toothed pinion 20 which is in engagement with the rack on the circular chassis 16. When the motor is brought into service, it thus drives the entire installation in rotation in the direction of the arrow F.

Each filtration cell is provided with a roller 21 which, in the example illustrated, is arranged on it on the side facing the centre of the device. The roller 21 is arranged so as to be able to turn freely about a pivot axis 22. This axis 22 preferably extends radially between the central rotation axis 2 of the device and the tilt axis 3 of the corresponding cell, in plan view, when the cell is in the horizontal position.

Advantageously, the pivot axis 22 of a roller 21 is thus situated in a plane passing through the rotation axis 2 of the device and perpendicular to the tilt axis 3 of the cell corresponding to the roller, throughout any tilting movement of the cell.

In a part of the device situated to the right in FIG. 1 a guide rail 23 is arranged so as to receive the roller 22 of each driven filtration cell.

In the example illustrated, the guide rail 23 is supported above the filtration cells by two brackets 24 and 25, whose ends towards the centre are supported by a cross-member 26. Shanks 27 each provided with a suspension clamp 43 fixedly hold the guide rail 23 suspended above the filtration cells. The rail 23 has a U shape, in the plan view in FIG. 1, and comprises a central part 30 and two lateral branches 28 and 29.

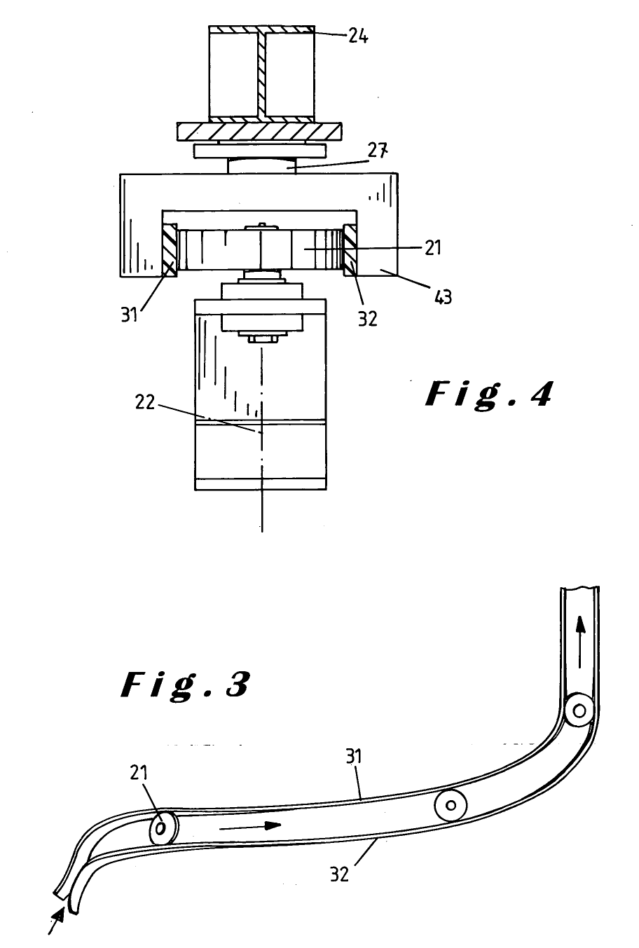

This guide rail 23 is formed, in the example illustrated, from two lateral walls 31 and 32 which extend parallel over the entire path of the rail. Between these two walls, the roller 21 follows a direction of forward movement illustrated by the arrows in FIG. 3.

As illustrated in FIGS. 1 and 2, when the roller 21 of a filtration cell reaches the central part 30 of the guide rail 23, the cell is in a substantially vertical position.

A station for cleaning the filter bed 41 and the back of the cell is provided in the example illustrated. It comprises two lances 33 and 34 which are provided with spray nozzles and which are supplied with a cleaning liquid. These lances spray this liquid onto the filtration cells in an approximately vertical position, which allows discharge of the sprayed liquids by gravity, into a collecting receptacle which is not shown.

Each filtration cell is advantageously provided with means of adjusting its horizontality. These means consist, in the example illustrated, of a lug 35 extending downwards from the edge of the cell disposed facing the centre of the device. This lug is provided with a rim having a threaded hole into which a threaded rod 36 can be screwed. This threaded rod 36, the end of which is thus adjustable for height, by screwing, bears against a stop 37 which extends, in the case illustrated, between the two rods 10 of the linkages 8 and 9 supporting the filtration cell.

The supply of the filtration cells with fluid to be filtered takes place in a normal fashion through the top of the cells. The filtrate is discharged through an orifice 42 situated at the bottom of each cell. This orifice is connected by a flexible conduit 38 to a central collector/distributor 39.

As is clear from FIG. 5, which is a view in a radial section through the device according to the invention, the flexible conduit 38 is depicted in solid lines in the filtration position at the cell and in broken lines in its tilted position. In the filtration position, it extends downwards along a substantially vertical axis 46 from the outlet orifice. When it passes at a height lower than the tilt axis 3, the flexible conduit 38 is then angled in the direction of the central collector 39 so as to continuously have a downward slope. So that, through its own weight, and through the weight of the filtrate which it receives, the conduit does not have a tendency to flex downwards and thus have a low position unfavourable to flow, in the example illustrated in FIG. 2 each flexible conduit 38 is supported partially by a channel 40 which turns with the cells. In the example illustrated in FIG. 5 it is a case rather of a local support 47, supporting the flexible conduit 38 in a central part thereof.

The slope of the flexible conduit may be variable, but it is everywhere greater than 0°.

As can be seen in FIG. 5, the length L of the flexible conduit between the outlet orifice 42 and the support 47 remains constant even when the cell is in the tilted position and the flexible conduit has been deformed. The part of the flexible conduit 38 between the support 47 and the collector 39 is not deformed and therefore also does not change length.

In the tilted position, the flexible conduit extends substantially horizontally from the outlet orifice 42 as far as the tilt axis 3 and is then angled in the direction of the collector 39.

As indicated in FIGS. 5 and 6, the bearing 6 has an outside diameter D1 and the flexible conduit an outside diameter D2. In the embodiment illustrated, the distance E between the tilt axis 3 and the substantially vertical axis 46 of the conduit is advantageously

$$\frac{D1 + D2}{2} .$$

Therefore, although this is not critical, and this distance E may be greater, it is preferable for it to be as close as possible to zero and that it be at most equal to D1+D2.

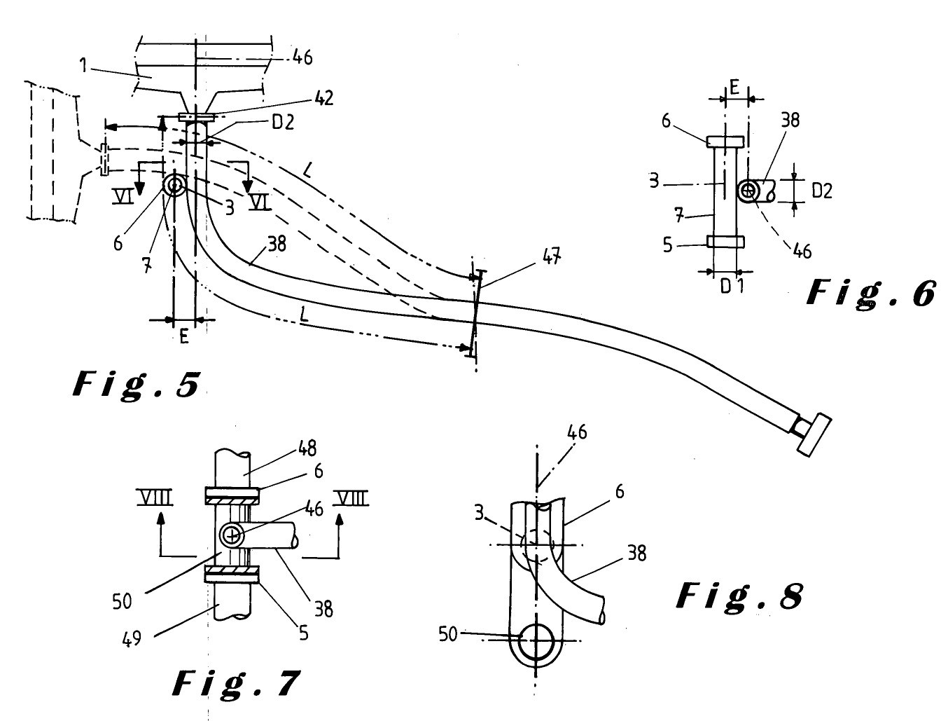

It is possible for example to imagine an embodiment as illustrated in FIGS. 7 to 8. There, the cell pivots about shaft ends 48 and 49 coaxial with each other and coaxial with the tilt axis 3, and the bearings 5 and 6 are maintained at a distance by an axially offset shaft 50 so as to form a kind of crankshaft. The axis 46 now crosses the tilt axis 3 and the distance E is equal to 0.

It is thus possible to imagine that the axis 46 is, in plan view, situated more towards the outside with respect to the tilt axis 3.

The functioning of the device illustrated is as followed.

The motor 19 drives the rack on the circular chassis 16 in rotation and with it each of the filtration cells in the direction F.

The cells are disposed horizontally, closely side by side, and are supplied with fluid to be filtered. The filtration of the fluid takes place through the filter bed 41, in a normal fashion, under negative pressure, obtained by means known per se.

The filtrate from each cell is discharged through the corresponding flexible conduit 38, and a filtration cake is formed above the filter bed. Because of the arrangement of the flexible conduit 38 continuously in a downward slope, discharge takes place easily, rapidly and without areas where the filtrate could stagnate and crystallise. Any part undergoing friction and wear, liable to permit leaks and entries of air, is avoided. The negative pressure is communicated without loss from the collector of the filtrate 39 as far as the bottom part of each cell in the filtration position.

At one moment, the roller 29 of the cell encounters the guide rail 23, as illustrated in FIG. 3. The rail forces the roller to rise and therefore the cell to tilt. Its inner end pivots upwards about the tilt axis 3. Approximately half-way from the branch 28 of the rail 23, the centre of gravity of the cell passes vertically to the tilt axis 3. Beyond that, the weight of the cell cooperates with its driving until it reaches the central part 30. Likewise, during the travel over the branch 29 of the guide rail, as soon as the centre of gravity of the cell once again passes vertically to the tilt axis 3, the weight of the cell participates in the driving thereof.

When the roller 21 follows the path of the central part of the guide rail 23, the cell is in an almost vertical position and therefore also the filter bed.

During this tilting, the flexible conduit 38 passes from the position depicted in solid lines in FIG. 5 to that depicted in broken lines. If there is a curvature deformation of the flexible conduit 38 upwards, no elongation thereof can be observed, nor any twisting about its longitudinal axis. Fatigue is therefore reduced to the minimum.

The filtration cake falls first of all onto the highly inclined external wall 44 of the cell, and then into a collector which is not shown, and the cell passes through the cleaning station already described, before once again tilting into the horizontal position and recommencing the filtration cycle.

Provision can advantageously be made, by means known per se, for the establishment of a slight back pressure of air inside each cell whilst the latter is in a position tilted to the vertical, in order to assist with the discharge of the filtration cake. This back pressure can be supplied from the collector 39, which then serves as a distributor, to the bottom of the cell, by means of the flexible conduit 38.

It must be understood that the present invention is in no way limited to the embodiment described above and that many modifications can be made thereto within the scope of the accompanying claims.

What we claim is:

1. A continuous fluid filtration device, comprising:
filtration cells each having an opening towards its top through which they are supplied with fluid to be filtered, the cells being fitted with a filter bed which, in the filtration position of the cells allows passage of a filtrate and retention of a filtration cake, and a bottom;
the cells being disposed in a carousel around a rotation axis and each cell arranged so as to be able to pivot about a tilt axis tangential to a horizontal circle having the rotation axis as its centre;
means for supporting the filtration cells so that each cell can perform a revolution about the rotation axis;
means for driving the filtration cells in revolution about the rotation axis;
means for moving the filtration cells to cause a tilting movement thereof about their tilt axis, during their revolution about the rotation axis; and
means for discharging the filtrate from the cells comprising at least one outlet orifice at the bottom of each cell, a central collector and connection means allowing flow of the filtrate between the said at least one outlet orifice and the collector,
said connection means for each cell comprising a flexible conduit in which, in the filtration position of the cell, no area of the flexible conduit is lower than another area of this conduit situated downstream with respect to the flow of the filtrate, the flexible conduit being arranged so as not to undergo any elongation during the tilting of the cell.

2. A device according to claim 1, characterised in that, in a radial section passing through the device, the flexible conduit in the filtration position of the cell extends downwards from an outlet orifice along a substantially vertical axis and then, at a height lower than the tilt axis, is angled in the direction of the collector so as to continuously have a downward slope, and in that the flexible conduit in the tilting position of the cell extends substantially horizontally from the outlet orifice as far as the tilt axis, and is then angled in the direction of the collector.

3. A device according to claim 2, characterised in that the tilt axis is supported in at least one bearing having a first outside diameter D1, in that the flexible conduit has a second outside diameter D2 and in that the distance between the tilt axis and the substantially vertical axis of the flexible conduit is equal to or greater than 0 and less than or equal to D1+D2.

4. A device according to claim 2, characterised in that the substantially vertical axis is, in the said radial section, situated between the tilt axis and the rotation axis.

5. A device according to claim 3, characterised in that the substantially vertical axis is, in the said radial section, situated between the tilt axis and the rotation axis.

6. A device according to claim 1, characterised in that each cell is supported on a shaft coaxial with the tilt axis so as to be able to pivot about this axis.

7. A device according to claim 2, characterised in that each cell is supported on a shaft coaxial with the tilt axis so as to be able to pivot about this axis.

8. A device according to claim 1, characterised in that each cell is supported on two shaft ends coaxial with each other and coaxial with the tilt axis so as to be able to pivot about this axis.

9. A device according to claim 2, characterised in that each cell is supported on two shaft ends coaxial with each other and coaxial with the tilt axis so as to be able to pivot about this axis.

10. A device according to claim 3, characterised in that each cell is supported on two shaft ends coaxial with each other and coaxial with the tilt axis so as to be able to pivot about this axis.

11. A device according to claim 1, characterised in that it comprises a support for each flexible conduit which turns about the rotation axis simultaneously with the filtration cells.

12. A device according to claim 2, characterised in that it comprises a support for each flexible conduit which turns about the rotation axis simultaneously with the filtration cells.

13. A device according to claim 3, characterised in that it comprises a support for each flexible conduit which turns about the rotation axis simultaneously with the filtration cells.

14. A device according to claim 1, characterised in that the collector is connected to a source of negative pressure which the flexible conduits connected to the filtration cells in the filtration position communicate to them, below their filter bed, and in that the collector is also a distributor connected to a source of pressurised gas which the flexible conduits connected to the filtration cells in the tilted position communicate to them, in order to assist with the detachment of the filtration cake from the filter bed.

15. A device according to claim 2, characterised in that the collector is connected to a source of negative pressure which the flexible conduits connected to the filtration cells in the filtration position communicate to them, below their filter bed, and in that the collector is also a distributor connected to a source of pressurised gas which the flexible conduits connected to the filtration cells in the tilted position communicate to them, in order to assist with the detachment of the filtration cake from the filter bed.

16. A device according to claim 3, characterised in that the collector is connected to a source of negative pressure which the flexible conduits connected to the filtration cells in the filtration position communicate to them, below their filter bed, and in that the collector is also a distributor connected to a source of pressurised gas which the flexible conduits connected to the filtration cells in the tilted position communicate to them, in order to assist with the detachment of the filtration cake from the filter bed.

17. A device according to claim 1, characterised in that the aforementioned tilling movement means comprises a roller arranged on each cell so as to be able to turn freely about a pivot axis, and a guide rail arranged fixedly at one point on the filtration device so as to receive the roller of each driven filtration cell and to guide it so as to cause the said tilting movement of the cell.

18. A device according to claim 17, characterised in that the pivot axis of each roller is situated in a plane passing through the rotation axis of the device and perpendicular to the tilt axis of the filtration cell corresponding to the roller.

19. A device according to claim 17, characterised in that the roller is carried by the cell at an internal end thereof.

20. A device according to claim 17, characterised in that the guide rail is disposed above the filtration cells so as to form a U in a plan view, comprising a central part and two lateral branches, the filtration surface of the cell being in an approximately vertical position when the roller reaches the central part of the U.
